(19) United States
(12) Patent Application Publication
(10) Pub. No.: US 2024/0091988 A1
(43) Pub. Date: Mar. 21, 2024

(54) MOLD FOR SUBSTRATE SURFACE FUNCTIONALIZATION, AND METHOD FOR SUBSTRATE SURFACE FUNCTIONALIZATION

(71) Applicant: ZHEJIANG HUASHUAITE NEW MATERIAL TECHNOLOGY CO., LTD., Jiaxing City, Zhejiang Province (CN)

(72) Inventors: JIEHAO QU, Jiaxing City, Zhejiang Province (CN); XIANGDONG LIU, Jiaxing City, Zhejiang Province (CN); SHENGJIONG YIN, Jiaxing City, Zhejiang Province (CN); SHUTING HE, Jiaxing City, Zhejiang Province (CN); QINQIN FAN, Jiaxing City, Zhejiang Province (CN); WANGJIE XU, Jiaxing City, Zhejiang Province (CN); HONGQIN ZHU, Jiaxing City, Zhejiang Province (CN)

(21) Appl. No.: 18/276,038

(22) PCT Filed: Dec. 2, 2021
(86) PCT No.: PCT/CN2021/134989

§ 371 Date: Aug. 6, 2023

(30) Foreign Application Priority Data
Sep. 22, 2021 (CN) 202111105711.1

(51) Int. Cl. B29C 33/00; B29C 33/12

(52) U.S. Cl. CPC B29C 33/0038; B29C 33/12

(57) ABSTRACT

The present application relates to a mold for substrate surface functionalization. In the mold, a rubber strip is provided between an upper mold plate and a lower mold plate in a clamping manner, and a fastening structure enables the upper mold plate and the lower mold plate to clamp in opposite directions, such that the rubber strip, the upper mold plate and the lower mold plate form a mold cavity together under the action of a clamping force; and a positioning structure is used for fixing a substrate in the mold cavity, such that a pouring space is formed between at least one side surface of the substrate and the upper mold plate and/or the lower mold plate, the pouring space being used for pouring a modified material for surface functionalization of the substrate. The present invention further relates to a method for substrate surface functionalization.

### CROSS-REFERENCE TO RELATED APPLICATION

The present application claims priority of Chinese patent application with the application date of Sep. 22, 2021, the application number 202111105711.1, and the title of “MOLD FOR SUBSTRATE SURFACE FUNCTIONALIZATION, AND METHOD FOR SUBSTRATE SURFACE FUNCTIONALIZATION”, the entire content of which is incorporated in the present application by reference.

### TECHNICAL FIELD

The present application relates to the technical field of molds, and in particular, to a mold for substrate surface functionalization and a method for substrate surface functionalization.

### BACKGROUND

Functionalization modification for a substrate can endow the substrate with other functions besides intrinsic functions, thereby improving the application performance of the substrate and expanding the application range of the substrate. Taking polymethyl methacrylate (PMMA, commonly known as organic glass) in polymer material substrates as an example, as a transparent polymer material with excellent comprehensive performance, it has been widely used in fields such as optoelectronic communication, noise control, energy conservation and environmental protection, biomedicine, aerospace, etc. In order to meet diverse demands for organic glass products in the market, it is necessary to develop various organic glass with new types of functions, such as insulation, self-cleaning, antibacterial, radiation protection, etc. Currently, comprehensive functionalization of organic glass is mainly realized during a single curing process of organic glass, there is a problem that it is difficult to regulate spatial distribution of expensive functional substances, a large amount of functional substances is required to be used, resulting in high manufacturing cost and difficulty in achieving ideal functionalization effect stably. If functionalization is only carried out on surfaces of organic glass, cost can be reduced; however, at present, functionalization on a surface of organic glass is mainly preformed by means of dipping, spraying, etc. Technical characteristics during implementation, such as differences in leveling performance, solvent volatilization, and so on, may lead to an uneven thickness and a shrinkage problem of a modified layer, affecting appearance presentation and use performance of functionalization. It can be seen that it is necessary to propose a surface modification solution for a substrate, so that a modified layer with smooth appearance and high thickness consistency can be obtained while reducing cost.

### SUMMARY OF THE DISCLOSURE

### Technical Problem

In order to meet diverse demands for organic glass products in the market, it is necessary to develop various organic glass with new types of functions, such as insulation, self-cleaning, antibacterial, radiation protection, etc. Currently, comprehensive functionalization of organic glass is mainly realized during a single curing process of organic glass, there is a problem that it is difficult to regulate spatial distribution of expensive functional substances, a large amount of functional substances is required to be used, resulting in high manufacturing cost and difficulty in achieving ideal functionalization effect stably. If functionalization is only carried out on surfaces of organic glass, cost can be reduced; however, at present, functionalization on a surface of organic glass is mainly preformed by means of dipping, spraying, etc. Technical characteristics during implementation, such as differences in leveling performance, solvent volatilization, and so on, may lead to an uneven thickness and a shrinkage problem of a modified layer, affecting appearance presentation and use performance of functionalization.

### Technical Solution

Aiming at the above technical problem, the present application provides a mold for substrate surface functionalization and a method for substrate surface functionalization, which can perform functionalization for only a surface of a substrate, thereby reducing cost, and obtaining a modified layer having even distribution, smooth appearance, and good thickness consistency.

In order to solve the above technical problem, the present application provides a mold for substrate surface functionalization, which comprises an upper mold plate, a lower mold plate, a rubber strip, a fastening structure, and a positioning structure; wherein the rubber strip is sandwiched between the upper mold plate and the lower mold plate, and the fastening structure clamps the upper mold plate and the lower mold plate towards each other, such that the rubber strip cooperates with the upper mold plate and the lower mold plate to form a mold cavity under action of a clamping force; the positioning structure is configured to fix a substrate in the mold cavity, such that a pouring space is formed between at least one side surface of the substrate and the upper mold plate and/or the lower mold plate, the pouring space is configured to pour a modified material for surface functionalization of the substrate.

Optionally, the positioning structure is an edge frame, the edge frame is positioned in the mold cavity under the action of the clamping force of the fastening structure, a side of the edge frame defines an opening and the opening is towards the rubber strip, an inside surface of the edge frame defines a positioning slot, the positioning slot is configured to fix the substrate in the edge frame, such that two side surfaces of the substrate cooperate with the upper mold plate and the lower mold plate to form corresponding pouring spaces respectively.

Optionally, a thickness of the pouring space formed between one side surface of the substrate and the upper mold plate is equal or unequal to a thickness of the pouring space formed between the other side surface of the substrate and the lower mold plate.

Optionally, the positioning structure is an edge frame, the edge frame is positioned in the mold cavity under the action of the clamping force of the fastening structure, a side of the edge frame defines an opening and the opening is towards the rubber strip, the edge frame is provided with a circle of positioning convex bar along an inside surface thereof, the positioning convex bar is configured to fix the substrate between the edge frame and the upper mold plate or between the edge frame and the lower mold plate, such that the pouring space is formed between one side surface of the substrate and the upper mold plate or the lower mold plate.

Optionally, the positioning structure comprises a plurality of positioning blocks, the positioning blocks are configured to be arranged on the substrate, portions of the positioning blocks being higher than a surface of the substrate abut against the upper mold plate and/or the lower mold plate to fix the substrate in the mold cavity, such that the pouring space is formed between at least one side surface of the substrate and the upper mold plate and/or the lower mold plate.

Optionally, the positioning blocks are arranged on at least one side surface of the substrate by means of adhesion; and/or the positioning blocks are arranged on the substrate by means of defining mounting holes in the substrate, and at least one side of each positioning block is higher than a surface of the substrate.

The present application further provides a method for substrate surface functionalization, comprising:
S1, fixing a substrate to be subjected to surface functionalization in the mold for substrate surface functionalization according to any one of claims 1-6, and pulling out a side of the rubber strip of the mold to reserve a pouring opening corresponding to each pouring space;
S2, pouring a modified material for surface functionalization of the substrate into the corresponding pouring space through the pouring opening;
S3, closing the pouring opening, and curing the modified material to form a modified layer on at least one side surface of the substrate.

Optionally, the substrate is a polymer material substrate, and the modified material is a mixture comprising functional substance, initiator, and monomer forming the substrate.

Optionally, the functional substance comprises substance with one or more of the functions of flame retardancy, enhancement, anti-static, fluorescence, color, electromagnetic shielding, noise reduction, anti-aging, radiation protection, heat insulation, antibacterial, self-cleaning, hardening, anti-glare, and heat resistance.

Optionally, the mass proportion of the functional substance is 80%, and the mass proportion of the monomer forming the substrate is 10%; at room temperature, the outflow time of the mixture measured with a Tu-4 viscometer is <150 seconds.

In the mold for substrate surface functionalization of the present application, the rubber strip is sandwiched between the upper mold plate and the lower mold plate, and the fastening structure clamps the upper mold plate and the lower mold plate towards each other, such that the rubber strip cooperates with the upper mold plate and the lower mold plate to form a mold cavity under action of a clamping force; the positioning structure is configured to fix a substrate in the mold cavity, such that a pouring space is formed between at least one side surface of the substrate and the upper mold plate and/or the lower mold plate, the pouring space is configured to pour a modified material for surface functionalization of the substrate. By this manner, a pouring structure for surface functionalization of the substrate can be formed, and the structure is simple.

In the method for substrate surface functionalization of the present application, a substrate to be subjected to surface functionalization is fixed in a mold for substrate surface functionalization; a modified material for surface functionalization of the substrate is poured into a corresponding pouring space through a pouring opening; and the modified material is cured to form a modified layer on at least one side surface of the substrate. By this manner, it is possible to perform functionalization for only a surface of a substrate, cost is reduced, and the obtained modified layer has even distribution, smooth appearance, and good thickness consistency.

### Advantageous Effect

In the mold for substrate surface functionalization of the present application, the rubber strip is sandwiched between the upper mold plate and the lower mold plate, and the fastening structure clamps the upper mold plate and the lower mold plate towards each other, such that the rubber strip cooperates with the upper mold plate and the lower mold plate to form a mold cavity under action of a clamping force; the positioning structure is configured to fix a substrate in the mold cavity, such that a pouring space is formed between at least one side surface of the substrate and the upper mold plate and/or the lower mold plate, the pouring space is configured to pour a modified material for surface functionalization of the substrate. A method for substrate surface functionalization is further involved, wherein a substrate to be subjected to surface functionalization is fixed in a mold for substrate surface functionalization; a modified material for surface functionalization of the substrate is poured into a corresponding pouring space through a pouring opening; and the modified material is cured to form a modified layer on at least one side surface of the substrate. By the manner of performing functionalization for only a surface of a substrate, a modified layer having even distribution, a smooth appearance, and a consistent thickness is obtained while reducing cost.

### BRIEF DESCRIPTION OF THE DRAWINGS

FIG. 1 is a structural schematic view of a mold for substrate surface functionalization shown according to a first embodiment.

FIG. 2 is a schematic view of using the mold for substrate surface functionalization shown according to the first embodiment.

FIG. 3 is a structural schematic view of the mold for substrate surface functionalization shown according to the first embodiment when viewed from above.

FIG. 4 is a structural schematic view of a positioning structure shown according to the first embodiment.

FIG. 5 is a schematic view of a matching structure of the positioning structure and a substrate shown according to the first embodiment.

FIG. 6 is a top view of a matching structure of a positioning structure and a substrate shown according to a second embodiment.

FIG. 7 is a front view of the matching structure of the positioning structure and the substrate shown according to the second embodiment.

FIG. 8 is a disassembled schematic view of the matching structure of the positioning structure and the substrate shown according to the second embodiment.

FIG. 9 is a schematic flow chart of a method for substrate surface functionalization shown according to a third embodiment.

### DETAILED DESCRIPTION

Implementation methods of the present application are illustrated below with specific embodiments. Those familiar with this technology can easily understand other advantages and effects of the present application from the content disclosed in this specification.

In the following description, reference is made to the accompanying drawings, which describe several embodiments of the present application. It should be understood that other embodiments can also be used, and changes in mechanical composition, structure, electrical, and operation can be made without departing from the spirit and scope of the present application. The detailed description below should not be considered as being restrictive, and the terminology used here is only for the purpose of describing specific embodiments and is not intended to limit the present application.

Although in some examples, the terms “first”, “second”, and the like are used to describe various components in this specification, these components should not be limited by these terms. These terms are only used to distinguish one component from another.

Furthermore, as used in this specification, singular forms “one”, “a”, and “the” are intended to also include plural forms, unless the context indicates otherwise. It should be further understood that terms “comprise” and “include” indicate existence of described features, steps, operations, elements, components, items, types, and/or groups, but do not exclude existence, appearance, or addition of one or more other features, steps, operations, elements, components, items, types, and/or groups. Terms “or” and “and/or” used herein are interpreted as being inclusive or implying any one or any combination. Therefore, “A, B, or C” or “A, B, and/or C” means “any of the following: A; B; C; A and B; A and C; B and C; A, B, and C”. Exceptions to this definition only occur when combinations of components, functions, steps, or operations are inherently mutually exclusive in certain ways.

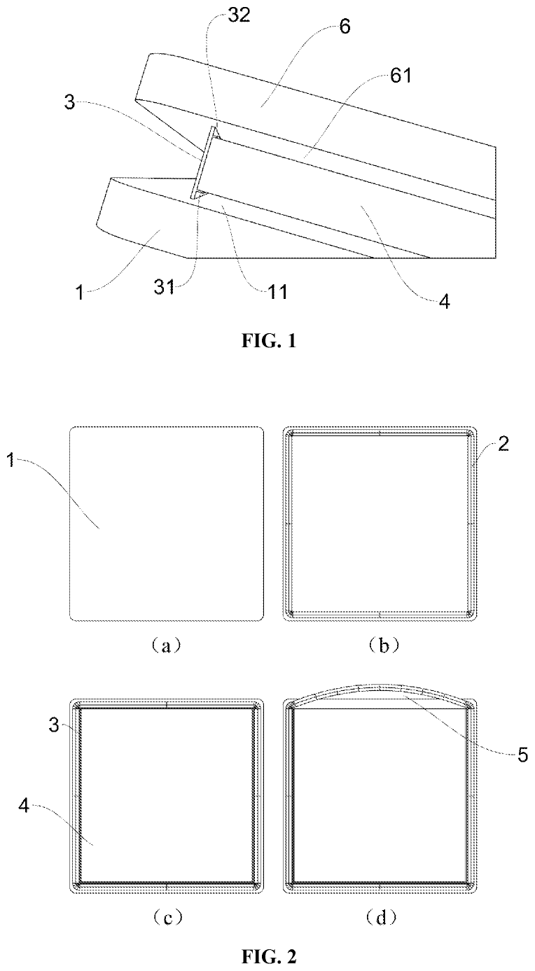

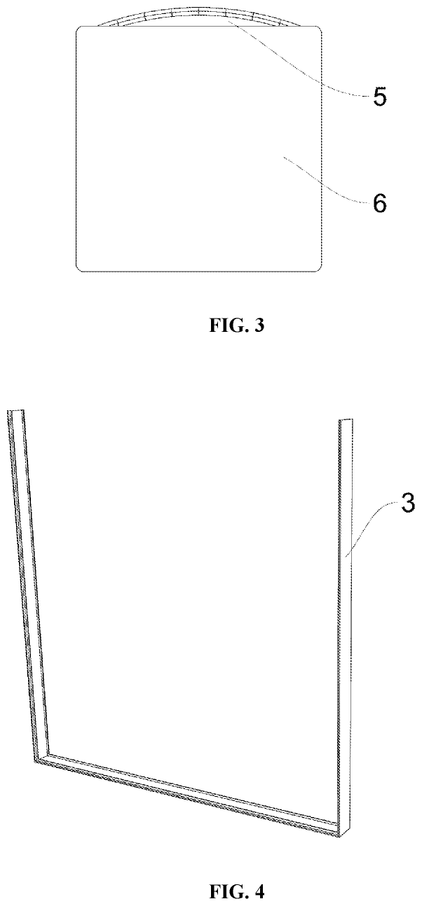

As shown in FIG. 1, FIG. 2, and FIG. 3, a mold for substrate surface functionalization in this embodiment includes an upper mold plate 6, a lower mold plate 7, a rubber strip 2 (not shown in FIG. 1 and not labeled in FIG. 3), a fastening structure (not shown in FIGS. 1-3), and a positioning structure. The rubber strip 2 is sandwiched between the upper mold plate 6 and the lower mold plate 1, and the fastening structure clamps the upper mold plate 6 and the lower mold plate 1 towards each other, such that the rubber strip 2 cooperates with the upper mold plate 6 and the lower mold plate 1 to form a mold cavity under action of a clamping force. The positioning structure is configured to fix a substrate 4 in the mold cavity, such that a pouring space is formed between at least one side surface of the substrate 4 and the upper mold plate 6 and/or the lower mold plate 1, the pouring space is configured to pour a modified material for surface functionalization of the substrate 4. In this embodiment, the positioning structure is an edge frame 3; in actual implementation, it is possible to select different positioning structures to use according to requirements.

Optionally, a shape of the upper mold plate 6 matches with that of the lower mold plate 1, and the upper mold plate 6 and the lower mold plate 1 have a thickness of 5 mm-20 mm and a surface roughness ≤25 μm. Optionally, the fastening structure is distributed at predetermined intervals on edges of the upper mold plate 6 and the lower mold plate 1, and the fastening structure is a screw device and/or a clamping device. Optionally, the upper mold plate 6 and the lower mold plate 1 are made of at least one of metal, tempered glass, and polymer.

Optionally, the substrate 4 is a substrate made of polymer material including but not limited to organic glass, polystyrene, PET, epoxy resin, ABS, polycarbonate, PVC, polyamide, polyimide, and polyurethane. Functional substances contained in the modified material include substances with one or more of the functions of flame retardancy, enhancement, anti-static, fluorescence, color, electromagnetic shielding, noise reduction, anti-aging, radiation protection, insulation, antibacterial, self-cleaning, hardening, anti-glare, and heat resistance.

Specifically, as shown in FIG. 2 (a) and (b), first, four steel wire rings (not shown in FIG. 2) are sheathed on the rubber strip 2; then head and tail joints of the rubber strip 2 are connected mutually after hot melting to form a circular rubber strip 2; then the four steel wire rings are respectively sheathed on four corners of the lower mold plate 1, so that the rubber strip 2 is constrained by directional tension of the steel wire rings to form a quadrilateral frame; afterwards, as shown in FIG. 2 (c), the substrate 4 is fixed in the edge frame 3 and placed flatly into the quadrilateral frame formed by the rubber strip 2; as shown in FIG. 2 (d), one side of the rubber strip 2 is pulled out, and the pulled out side of the rubber strip 2 is used to form a pouring opening 5; finally, as shown in FIG. 3, the upper mold plate 6 is covered and the fastening structure is distributed on places corresponding to the other three sides of the rubber strip 2 to clamp the upper mold plate 6 and the lower mold plate 1 towards each other. At this time, also referring to FIG. 1, the rubber strip 2 cooperates with the upper mold plate 6 and the lower mold plate 1 to form a mold cavity under action of a clamping force, the substrate 4 is fixed in the mold cavity by the edge frame 3, such that one pouring space (hereinafter referred to as “first pouring space 11”) is formed between one side surface of the substrate 4 and the lower mold plate 1, and another pouring space (hereinafter referred to as “second pouring space 61”) is also formed between the other side surface of the substrate 4 and the upper mold plate 6. The pulled out side of the rubber strip 2 forms a pouring opening 5 corresponding to the first pouring space 11 and the second pouring space 61. At this time, the steel wire rings can be cut off, thus assembly of the mold is completed. Afterwards, a modified material for surface functionalization of the substrate 4 can be slowly poured into the first pouring space 11 and the second pouring space 61 through the pouring opening 5. After pouring is completed, the pulled out side of the rubber strip 2 is inserted between the upper mold plate 6 and the lower mold plate 1, gas is discharged and the clamping force of the fastening structure on this side of the mold is adjusted. Finally, the modified material is cured, thus a modified layer can be formed on a surface of substrate 4.

It can be seen that the mold of the present application is simple in structure and can perform functionalization for only a surface of substrate 4. Compared with performing overall functionalization modification, fewer functional substances can be used to reduce cost. When using the same amount of functional substances, due to the concentrated distribution of the functional substances in the surface modification layer in this condition, better modification effect can be obtained than comprehensive overall functional modification. In addition, the formation of the modified layer by means of mold pouring can ensure the surface smoothness of the modified layer (which is controlled by the surface roughness of the mold), and the space after pouring is closed and has an appropriate positive pressure, which suppresses the formation of bubbles in the modified material during the curing process, thereby obtaining good compactness of the modified layer.

Optionally, as shown in FIG. 4 and FIG. 5, a side of the edge frame 3 defines an opening and an inside surface thereof defines a positioning slot, the positioning slot is configured to fix the substrate 4 in the edge frame 3. According to different shapes of substrate 4, such as quadrilateral or triangle, the edge frame 3 may be a right angle U-shaped edge frame, a rounded U-shaped edge frame, a right angle V-shaped edge frame, or a rounded V-shaped edge frame, with the positioning slot having an identical width. The shape of edge frame 3 is not limited here, as long as the substrate 4 can be fixed in the edge frame 3 by embedded in the positioning slot. Referring to FIG. 5, in this embodiment, the positioning groove of the edge frame 3 is formed by a space defined by a first side plate 31 and a second side plate 32, which are arranged to extend in parallel along the inside surface of the edge frame 3; a distance between the first side plate 31 and the second side plate 32 matches with the thickness of the substrate 4, wherein interference fit is preferably formed. Herein, both the first side plate 31 and the second side plate 32 are higher than the inside surface of the edge frame 3; in actual use, it is also possible to select a form of being lower than the inside surface of the edge frame 3, that is, the positioning slot is embedded in the inside surface of the edge frame 3. Optionally, in a thickness direction of the edge frame 3, a distance a between the first side plate 31 and an edge of the edge frame 3 may be equal or unequal to a distance b between the second side plate 32 and an edge of the edge frame 3, so that a thickness of the first pouring space 11 formed between one side surface of the substrate 4 and the lower mold plate 1 may be equal or unequal to a thickness of the second pouring space 61 formed between the other side surface of the substrate 4 and the upper mold plate 6. In this way, the thickness of the edge frame 3 and positions of the first side plate 31 and of the second side plate 32 can be designed according to a required thickness of a modified layer, thereby achieving precise adjustment for the thickness of the modified layer.

Optionally, when the edge frame 3 is selected as the positioning structure, it is also possible to provide a circle of positioning convex bar along only an inside surface of the edge frame 3, the positioning convex bar is configured to fix the substrate 4 between the edge frame 3 and the upper mold plate 6 or between the edge frame 3 and the lower mold plate 1, such that a pouring space is formed between a side surface of the substrate 4 and the upper mold plate 6 or the lower mold plate 1; another side surface of the substrate 4 is in contact with the lower mold plate 1 or the upper mold plate 6 and is not modified, in this case, a protective film needs to be attached in advance to the side surface of the substrate 4 that is in tight contact with the lower mold plate 1 or the upper mold plate 6 for easy removal after subsequent molding and to make the side surface keep being smooth. When the circle of positioning convex bar is provided along only the inside surface of the edge frame 3, a distance between the positioning convex bar and an edge of a side of the inside surface of the edge frame 3 matches the thickness of the modified layer, a distance between the positioning convex bar and an edge of another side of the inside surface of the edge frame 3 matches the thickness of the substrate 4, and interference fit is preferably formed. In this way, by providing the circle of positioning convex bare along only the inside surface of the edge frame 3, it can be suitable for forming the modified layer on only one side of the substrate 4, the structure is simple.

When the edge frame 3 is positioned in the mold cavity under the action of the clamping force of the fastening structure, the opening at the side of the edge frame 3 is towards the rubber strip 2, so that the pulled out side of the rubber strip 2 can be in correspondence with the position of the opening of the edge frame 3, thereby forming the pouring opening 5. It should be noted that under the clamping force of the fastening structure, upper and lower surfaces of the edge frame 3 directly contact the upper mold plate 6 and lower mold plate 1 to define the pouring space. The overall appearance size of the edge frame 3 is slightly smaller than the size of the quadrilateral frame formed by rubber strip 2 constrained by directional tension, and it is preferable that it can be just placed therein. The thickness size of edge frame 3 matches the diameter of rubber strip 2 (in a non-forced state, the thickness of the edge frame 3 is slightly smaller than the diameter of rubber strip 2); after the fastening structure is locked, the thickness of edge frame 3 after being forced is equal to the thickness of the mold cavity between the upper mold plate 6 the lower mold plate 1 at this time (i.e. the thickness of the rubber strip 2 after being forced at this time); it can also be considered that the positioning structure can provide a limit prompt for locking the fastening structure, so that a binding force generated by each fastening structure is as consistent as possible.

The rubber strip 2 needs to be selected with appropriate diameter and length to ensure sealing of the pouring space. Among them, the diameter of the rubber strip 2 can be selected based on the overall thickness of the substrate 4 after modification and the thickness of the edge frame 3, so that the substrate with a required thickness can be obtained after vertical binding of the fastening structure and curing of the modified material. The length of the rubber strip 2 can be selected based on overall dimensions of the upper mold plate 6, the lower mold plate 1, and the edge frame 3, and it is necessary to consider an inward tension distance formed after nesting of the steel wire rings, this distance is generally within 5 cm in length. Therefore, within the constraint condition that a circumference of rubber strip 2 is smaller than that of the upper mold plate 6 and the lower mold plate 1, it can be selected according to actual situations, and it is preferable that the tension of the rubber strip 2 after nesting of the steel wire rings is appropriate. In actual implementation, the rubber strip 2 is constrained by a directional tension to form a quadrilateral frame, which is a common form when using rectangular or square mold plates. If mold plates with other geometric shapes are used, a current shape of the rubber strip 2 will change accordingly; for example, when using a triangular mold plate, the rubber strip 2 is constrained by a directional tension to form a triangular frame.

### Second Embodiment

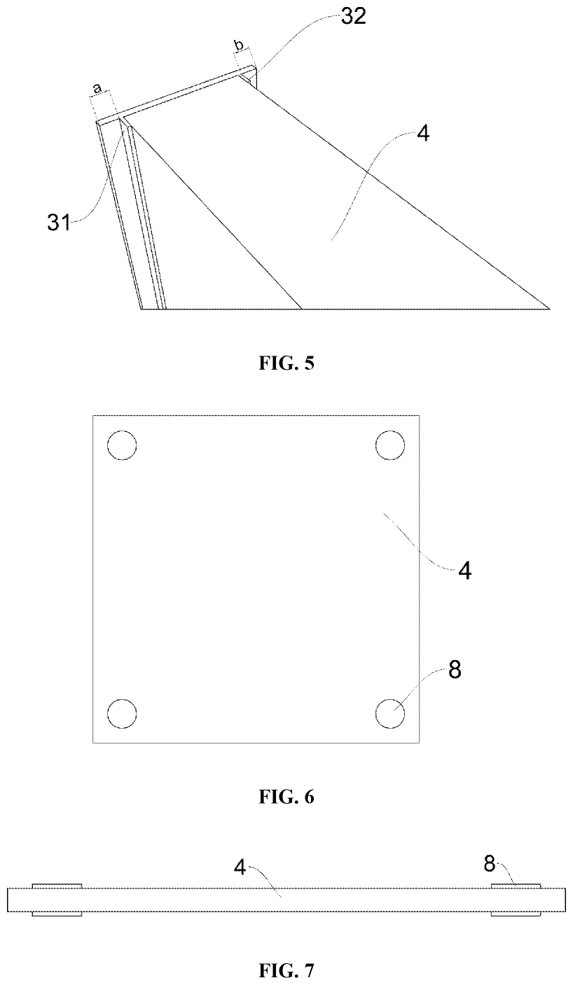

FIG. 6 is a top view of a matching structure of a positioning structure and a substrate shown according to a second embodiment; FIG. 7 is a front view of the matching structure of the positioning structure and the substrate shown according to the second embodiment. As shown in FIG. 6 and FIG. 7, differing from the first embodiment, the positioning structure in this embodiment includes a plurality of positioning blocks 8; the positioning blocks 8 are configured to be arranged on the substrate 4, portions of the positioning blocks 8 being higher than a surface of the substrate 4 abut against the upper mold plate and/or the lower mold plate to fix the substrate 4 in the mold cavity, such that the pouring space is formed between at least one side surface of the substrate 4 and the upper mold plate and/or the lower mold plate.

Optionally, material of the positioning blocks 8 may be any material, such as resin categories, metal categories, or inorganic categories.

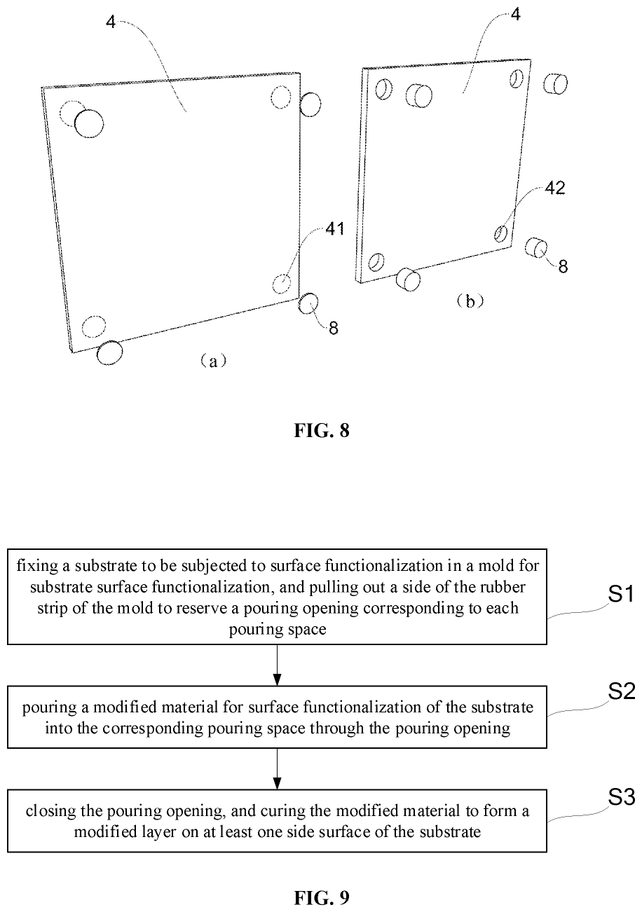

Optionally, as shown in FIG. 8(a), the positioning blocks 8 are arranged on at least one side surface of the substrate 4 by means of adhesion. The positioning block 8 adopts thin sheets with an identical thickness and are adhered to designated areas 41 on upper and/or lower surfaces of the substrate 4. The designated areas 41 generally include peripheral edge positions or a central area, their quantity is not specially limited and can be selected appropriately according to thickness and accuracy needs, the larger the quantity, the better the thickness consistency of the obtained modified layer. In addition, the larger the size of the substrate 4, for example, when both the length and the width are greater than 0.5 meters, in order to prevent deformation under gravity interference, it is necessary to dispose the thin sheets with an identical thickness in the central area. During adhesion, taking the substrate 4 as organic glass and the positioning block 8 as organic glass material as examples, organic solvents that can dissolve PMMA material, such as acetone, chloroform, methyl methacrylate, etc., can be selected to be dripped or coated on corresponding positions of the substrate 4 or the thin sheets with an identical thickness, and then pressure adhesion is performed to make the positioning blocks 8 of organic glass material tightly bond with the substrate 4 under moderate dissolution of the aforementioned organic solvents. In actual implementation, when the material of the positioning blocks 8 is different from that of the substrate 4, that is, in the above example, when the positioning blocks 8 are no longer made of organic glass material, the adhesion technology will be adjusted accordingly, and the above organic solvents will no longer be used. Instead, one of polyurethane, epoxy resin, acrylic ester, and organic silicon adhesives may be used. The positioning blocks 8 can be adhered to both two side surfaces of the substrate 4, and the substrate 4 with modified layers on both two surfaces will be finally obtained; the positioning blocks 8 can also be adhered to only one side of the substrate 4, and a substrate 4 with a single-sided modified layer will be obtained. At this time, a protective film needs to be attached in advance to the side of the substrate 4 that is not attached with the positioning blocks 8, and removed after molding to ensure a smooth surface of the substrate 4. The thickness of one positioning block 8 plus the thickness of the substrate 4 is the thickness of the mold cavity between the upper mold plate and the lower mold plates, and the thickness of the modified layer is controlled by thicknesses and sizes of the positioning blocks 8.

Optionally, as shown in FIG. 8(b), the positioning blocks 8 can also be arranged on the substrate 4 by means of defining mounting holes in the substrate 4, and at least one side of each positioning block 8 is higher than a surface of the substrate 4. Through-holes 42 are defined at positions on the substrate 4 where the positioning block 8 needs to be disposed, the positioning blocks 8 adopt columns with an identical thickness, and a diameter of each positioning block 8 is slightly larger than that of the through-hole 42 for interference assembly. At least one side of each positioning block 8 should be higher than a surface of the substrate 4, and the higher part forms the pouring space for the modified layer. The thickness of the modified layer is controlled by sizes of the positioning blocks 8 being higher than upper and lower surfaces of the substrate 4. Among them, each positioning block 8 can have both upper and lower sides extending beyond surfaces of the substrate 4; can also have one side being flush with a surface of the substrate 4 and only one side extending beyond a surface of the substrate 4; and can also have one side embedded in the through-hole 42 and only one side extending beyond a surface of the substrate 4. In the latter two flush or embedded cases, the surface of substrate 4 corresponding to the non-exceeded side of the positioning block 8 needs to be treated with a protective film in advance, and the protective film is removed after molding to ensure a smooth surface of the substrate 4.

The rubber strip 2 needs to be selected with appropriate diameter and length to ensure sealing of the pouring space. Differing from the first embodiment, the diameter of the rubber strip 2 can be selected based on the overall thickness of the substrate 4 after modification and the overall thickness of the substrate 4 plus the positioning blocks 8, so that the substrate 4 with a required thickness can be obtained after vertical binding of the fastening structure and curing of the modified material. The length of the rubber strip 2 can be selected based on overall dimensions of the upper mold plate and the lower mold plate, and it is necessary to consider an inward tension distance formed after nesting of the steel wire rings, this distance is generally within 5 cm in length. Therefore, within the constraint condition that a circumference of rubber strip 2 is smaller than that of the upper mold plate and the lower mold plate, it can be selected according to actual situations, and it is preferable that the tension of the rubber strip 2 after nesting of the steel wire rings is appropriate.

### Third Embodiment

FIG. 9 is a schematic flow chart of a method for substrate surface functionalization shown according to a third embodiment. As shown in FIG. 9, the present application further provides a method for substrate surface functionalization, comprising:
S1, fixing a substrate to be subjected to surface functionalization in a mold for substrate surface functionalization, and pulling out a side of the rubber strip of the mold to reserve a pouring opening corresponding to each pouring space;
S2, pouring a modified material for surface functionalization of the substrate into the corresponding pouring space through the pouring opening;
S3, closing the pouring opening, and curing the modified material to form a modified layer on at least one side surface of the substrate.

The mold used for surface functionalization of the substrate is the mold in the first embodiment and/or second embodiment, and the assembly process of the mold in the above steps can refer to the first embodiment. Among them, the number of the steel wire rings sheathed on the rubber strip is more than or equal to four, as common upper mold plates and lower mold plates are mainly rectangular or square. However, it is not ruled out that there are triangular upper mold plates and lower mold plates, therefore, using three steel wire rings can also be implemented in this case, and the rubber strip is constrained by directional tension to form a triangular frame at this time. In actual implementation, the number of the steel wire rings can be slightly more than the number of edges and corners of the mold plates. Additional steel wire rings after nesting use can provide convenient force application positions when pulling out one side of the rubber strip. In addition, the head and tail joints of the rubber strip are connected after hot melting; if hot melting or docking is carried out manually, attention should be paid to keeping both hands being horizontal as much as possible to make edges of the connection portions be neat, which is conducive to sealing of the mold cavity between the upper mold plate and the lower mold plate in the future. When assembling the mold, related components that form direct contact with the substrate, such as the upper mold plate, the lower mold plate, the positioning structure, the rubber strip, and so on, are all subjected to appropriate surface cleaning treatment, including but not limited to high-pressure air guns, cleaning drying, wiping, etc. The specific appropriate selection depends on the process requirements and on-site conditions, without any special restriction.

In the step S3, the modified material can be cured by water bath (or air bath) treatment at 50-70° C. for 1-5 hours and 100-130° C. for 1-5 hours.

Optionally, the substrate is a polymer material substrate, and the modified material is a mixture including functional substance, initiator, and monomer forming the substrate. Taking a substrate of organic glass as an example, the modified material can be a mixture including specific functional substance, initiator, and MMA; or taking a substrate of polystyrene as an example, the modified material can be a mixture including specific functional substance, initiator, and styrene.

Taking a substrate of organic glass as an example, since the poured modified material contains monomer MMA for forming the substrate, it can gently dissolve or swell a surface of the substrate in contact, so that polymer chains of polymer (PMMA) forming the surface of the substrate generate micro relaxation, which provides moderate space for infiltration or solubilization of the modified material; in an area of the surface of the substrate with a certain thickness, it is possible to achieve a polymer solution state formed by combination of the modified material and the substrate surface polymer (PMMA), which is cured and formed after subsequent implementation of free radical polymerization. In this way, the surface of the original substrate is completely integrated with the modified layer, that is, the phase interface no longer appears, and a single phase composite modified structure is achieved. This microstructure state can effectively ensure adhesion reliability of the modified layer in use, and there will be no peeling, dropping, or other failure situations. Compared with functional modification performed by means of currently common surface coating techniques such as immersion coating, spray coating, vapor deposition, and so on, the solution proposed in the present application will completely change the problem of low reliability of a functional modification layer on a surface of a substrate. In addition, due to the controllable thickness of the modified layer, there is no need for comprehensive overall pouring modification, which can significantly reduce cost of raw materials.

Optionally, the functional substance comprises substance with one or more of the functions of flame retardancy, enhancement, anti-static, fluorescence, color, electromagnetic shielding, noise reduction, anti-aging, radiation protection, heat insulation, antibacterial, self-cleaning, hardening, anti-glare, and heat resistance.

Optionally, when the modified material is a mixture including functional substance, initiator, and monomer forming the substrate, the mass proportion of the functional substance is ≤80%, and the mass proportion of the monomer forming the substrate is ≥10%; thus, it is possible to improve the degree of polymerization of the modified layer and thereby improve mechanical properties of the modified layer while ensuring the adhesion force of the modified layer.

Optionally, the modified material can further include a matrix polymer to adjust viscosity of the modified material. Taking a substrate of organic glass as an example, the modified material can be a mixture including specific functional substance, initiator, PMMA, and MMA. Alternatively, taking a substrate of polystyrene as an example, the modified material can be a mixture including specific functional substance, initiator, polystyrene, and styrene.

Optionally, when the modified material is a mixture including specific functional substance, initiator, monomer forming the substrate, and matrix polymer, the mass proportion of the functional substance is 60%, the mass proportion of the monomer forming the substrate is 10%, and the mass proportion of the matrix polymer is 30%, so that the viscosity of the modified material can adjusted into a proper range.

Optionally, at room temperature (e.g., 25° C.), the outflow time of the mixture measured with a Tu-4 viscometer is <150 seconds. The specific viscosity value needs to be appropriately selected based on density of the functional substance and stability of the pouring and curing process. If the density of the functional substance is higher, the viscosity of the mixture also increases correspondingly to maintain excellent anti-settlement performance. In addition, the outflow time of the mixture should not exceed 150 seconds because a too high viscosity is not conducive to floating and elimination of bubbles during the pouring process. As a whole, without being affected by the bubble elimination problem, the viscosity can be appropriately selected in a larger direction, which is beneficial for the sealing performance of the mold and ensures the stability of the forming process.

In the method for substrate surface functionalization of the present application, a substrate to be subjected to surface functionalization is fixed in a mold for substrate surface functionalization; a modified material for surface functionalization of the substrate is poured into a corresponding pouring space through a pouring opening; and the modified material is cured to form a modified layer on at least one side surface of the substrate. By this manner, it is possible to perform functionalization for only a surface of a substrate, cost is reduced, and the obtained modified layer has even distribution, a reliable adhesion force, smooth appearance, and good thickness consistency. Furthermore, a substrate, of which a surface has functions of flame retardancy, enhancement, anti-static, fluorescence, color, electromagnetic shielding, noise reduction, anti-aging, radiation protection, heat insulation, self-cleaning, antibacterial, hardening, heat resistance, and so on, is obtained by a convenient forming manner.

The above embodiments are only illustrative explanations of principles and effect of the present application, and are not intended to limit the present application. Anyone familiar with this technology may modify or change the above embodiments without violating the spirit and scope of the present application. Therefore, all equivalent modifications or changes made by those with ordinary knowledge in the technical field without departing from the spirit and technical ideas disclosed in the present application shall still be covered by the claims of the present application.

### INDUSTRIAL APPLICABILITY

In the mold for substrate surface functionalization of the present application, the rubber strip is sandwiched between the upper mold plate and the lower mold plate, and the fastening structure clamps the upper mold plate and the lower mold plate towards each other, such that the rubber strip cooperates with the upper mold plate and the lower mold plate to form a mold cavity under action of a clamping force; the positioning structure is configured to fix a substrate in the mold cavity, such that a pouring space is formed between at least one side surface of the substrate and the upper mold plate and/or the lower mold plate, the pouring space is configured to pour a modified material for surface functionalization of the substrate. A method for substrate surface functionalization is further involved, wherein a substrate to be subjected to surface functionalization is fixed in a mold for substrate surface functionalization; a modified material for surface functionalization of the substrate is poured into a corresponding pouring space through a pouring opening; and the modified material is cured to form a modified layer on at least one side surface of the substrate. By the manner of performing functionalization for only a surface of a substrate, a modified layer having even distribution, a smooth appearance, and a consistent thickness is obtained while reducing cost.

1. A mold for substrate surface functionalization, comprising: an upper mold plate, a lower mold plate, a rubber strip, a fastening structure, and a positioning structure; wherein the rubber strip is sandwiched between the upper mold plate and the lower mold plate, and the fastening structure clamps the upper mold plate and the lower mold plate towards each other, such that the rubber strip cooperates with the upper mold plate and the lower mold plate to form a mold cavity under action of a clamping force; the positioning structure is configured to fix a substrate in the mold cavity, such that a pouring space is formed between at least one side surface of the substrate and the upper mold plate and/or the lower mold plate, the pouring space is configured to pour a modified material for surface functionalization of the substrate.

2. The mold for substrate surface functionalization according to claim 1, wherein the positioning structure is an edge frame, the edge frame is positioned in the mold cavity under the action of the clamping force of the fastening structure, a side of the edge frame defines an opening and the opening is towards the rubber strip, an inside surface of the edge frame defines a positioning slot, the positioning slot is configured to fix the substrate in the edge frame, such that two side surfaces of the substrate cooperate with the upper mold plate and the lower mold plate to form corresponding pouring spaces respectively.

3. The mold for substrate surface functionalization according to claim 1, wherein the positioning structure comprises a plurality of positioning blocks, the positioning blocks are configured to be arranged on the substrate, portions of the positioning blocks being higher than a surface of the substrate abut against the upper mold plate and/or the lower mold plate to fix the substrate in the mold cavity, such that the pouring space is formed between at least one side surface of the substrate and the upper mold plate and/or the lower mold plate.

4. The mold for substrate surface functionalization according to claim 3, wherein the positioning blocks are arranged on at least one side surface of the substrate by means of adhesion; and/or the positioning blocks are arranged on the substrate by means of defining mounting holes in the substrate, and at least one side of each positioning block is higher than a surface of the substrate.

5. The mold for substrate surface functionalization according to claim 1, wherein a thickness of the pouring space formed between one side surface of the substrate and the upper mold plate is equal or unequal to a thickness of the pouring space formed between the other side surface of the substrate and the lower mold plate.

6. The mold for substrate surface functionalization according to claim 1, wherein the positioning structure is an edge frame, the edge frame is positioned in the mold cavity under the action of the clamping force of the fastening structure, a side of the edge frame defines an opening and the opening is towards the rubber strip, the edge frame is provided with a circle of positioning convex bar along an inside surface thereof, the positioning convex bar is configured to fix the substrate between the edge frame and the upper mold plate or between the edge frame and the lower mold plate, such that the pouring space is formed between one side surface of the substrate and the upper mold plate or the lower mold plate.

7. A method for substrate surface functionalization, comprising:
S1, fixing a substrate to be subjected to surface functionalization in the mold for substrate surface functionalization according to claim 1, and pulling out a side of the rubber strip of the mold to reserve a pouring opening corresponding to each pouring space;
S2, pouring a modified material for surface functionalization of the substrate into the corresponding pouring space through the pouring opening;
S3, closing the pouring opening, and curing the modified material to form a modified layer on at least one side surface of the substrate.

8. The method for substrate surface functionalization according to claim 7, wherein the substrate is a polymer material substrate, and the modified material is a mixture comprising functional substance, initiator, and monomer forming the substrate.

9. The method for substrate surface functionalization according to claim 8, wherein the functional substance comprises substance with one or more of the functions of flame retardancy, enhancement, anti-static, fluorescence, color, electromagnetic shielding, noise reduction, anti-aging, radiation protection, heat insulation, antibacterial, self-cleaning, hardening, anti-glare, and heat resistance.

10. The method for substrate surface functionalization according to claim 8, wherein the mass proportion of the functional substance is ≤80%, and the mass proportion of the monomer forming the substrate is ≥10%; at room temperature, the outflow time of the mixture measured with a Tu-4 viscometer is <150 seconds.
